(19) United States
(12) Patent Application Publication
(10) Pub. No.: US 2013/0009949 A1
(43) Pub. Date: Jan. 10, 2013

(54) METHOD, SYSTEM AND COMPUTER PROGRAM PRODUCT FOR RE-CONVERGENCE OF A STEREOSCOPIC IMAGE

(75) Inventors: Gregory Robert Hewes, Sachse, TX (US); Wei Hong, Sunnyvale, CA (US); Fred William Ware, JR., DeSoto, TX (US)

(73) Assignee: TEXAS INSTRUMENTS INCORPORATED, Dallas, TX (US)

(21) Appl. No.: 13/478,241

(22) Filed: May 23, 2012

Related U.S. Application Data
(60) Provisional application No. 61/504,592, filed on Jul. 5, 2011.

(51) Int. Cl. G06T 15/00

(52) U.S. Cl. 345/419

(57) ABSTRACT

First and second views of a stereoscopic image are received. A first portion of the stereoscopic image is located at a first coordinate that is equal within the first and second views. For displaying enlarged versions of the first and second views, at least one of the first and second views is shifted, so that a second portion of the stereoscopic image is located at a second coordinate that is equal within the enlarged versions.

### CROSS-REFERENCE TO RELATED APPLICATION

This application claims priority to U.S. Provisional Patent Application Ser. No. 61/504,592, filed Jul. 5, 2011, entitled STEREOSCOPIC RE-CONVERGENCE FOR PLAYBACK MAGNIFICATION AND DISPLAY OPTIMIZATION, naming Gregory Robert Hewes et al. as inventors, which is hereby fully incorporated herein by reference for all purposes.

### BACKGROUND

The disclosures herein relate in general to digital image processing, and in particular to a method, system and computer program product for re-convergence of a stereoscopic image.

A stereoscopic camera system's convergence distance is a distance from the system's cameras to a convergence plane where viewing axes (of the system's cameras) intersect. Similarly, a human's convergence distance is a distance from the human's eyes to a convergence plane where the eyes' viewing axes intersect. In one example, the stereoscopic camera system's convergence distance is either: (a) infinity (for a parallel camera configuration); or (b) a fixed distance (for a toe-in camera configuration).

The human's convergence distance is variable. For example, if the human views an image (e.g., within a video sequence of images) on a display screen, then the human's eyes naturally converge to the display screen. Accordingly, the human's natural convergence distance is a distance from the display screen to the eyes.

Nevertheless, if the human views the image with three-dimensional (“3D”) effect on a stereoscopic display screen that receives the image from a stereoscopic camera system, then the human's eyes adjust to the image's convergence distance, so that the human may correctly experience the 3D effect. If the image's convergence distance varies from the human's natural convergence distance, then such variation (e.g., from image-to-image or scene-to-scene) can strain the human's viewing of the image with 3D effect, thereby causing the human's eventual discomfort (e.g., headaches and/or eye muscle pain). Such discomfort is a shortcoming, which discourages the human's viewing of the image with 3D effect on the stereoscopic display screen.

### SUMMARY

First and second views of a stereoscopic image are received. A first portion of the stereoscopic image is located at a first coordinate that is equal within the first and second views. For displaying enlarged versions of the first and second views, at least one of the first and second views is shifted, so that a second portion of the stereoscopic image is located at a second coordinate that is equal within the enlarged versions.

### BRIEF DESCRIPTION OF THE DRAWINGS

FIG. 1 is a block diagram of an information handling system of the illustrative embodiments.

FIG. 2 is a diagram of viewing axes of a human's eyes.

FIG. 3A is a diagram of a left image for viewing by a left eye on a display device of the system of FIG. 1.

FIG. 3B is a diagram of a right image for viewing by a right eye on the display device.

FIG. 4 is a diagram of a touchscreen of the display device in a first embodiment.

FIG. 5 is a diagram of the touchscreen, on which a user has selected a portion that displays a portion of a truck.

FIG. 6A is a diagram of an enlarged version of the left image of FIG. 3A.

FIG. 6B is a diagram of an enlarged version of the right image of FIG. 3B.

FIG. 6C is a diagram of the enlarged version of the right image of FIG. 3B, after a conversion device of the system of FIG. 1 has adjusted a convergence plane.

FIG. 7 is a diagram of features at various depths within the image of FIGS. 3A and 3B.

FIG. 8A is a diagram of the left image of FIG. 3A, in which the conversion device has selected a new convergence plane.

FIG. 8B is a diagram of the right image of FIG. 3B, in which the conversion device has likewise selected the new convergence plane.

FIG. 8C is a diagram of a displayable version of the right image of FIG. 3B, after the conversion device has adjusted the convergence plane.

FIG. 9 is a diagram of features at various depths within the image, after the conversion device has adjusted the convergence plane.

FIG. 10A is a diagram of a cropped version of the left image of FIG. 8A, after the conversion device has adjusted the convergence plane.

FIG. 10B is a diagram of a cropped version of the right image of FIG. 8C.

FIG. 11 is a flowchart of operation of the conversion device.

### DETAILED DESCRIPTION

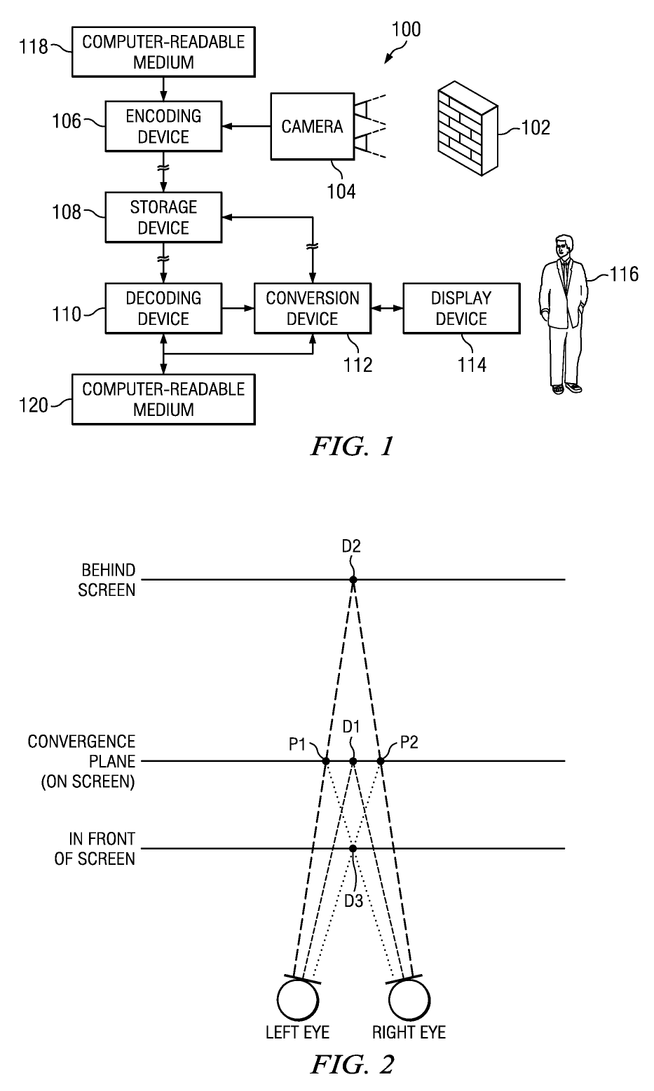

FIG. 1 is a block diagram of an information handling system (e.g., a portable battery-powered electronics device, such as a mobile smartphone, a tablet computing device, a netbook computer, or a laptop computer), indicated generally at 100, of the illustrative embodiments. In the example of FIG. 1, a physical object 102 and its surrounding foreground and background are viewed by a stereoscopic camera system 104, which: (a) digitizes images of such views; and (b) outputs a video sequence of such digitized (or “digital”) images to an encoding device 106. In the example of FIG. 1, the camera system 104 includes dual imaging sensors, which are offset horizontally for capturing images of left and right views, respectively. The encoding device 106: (a) receives such digitized images from the camera system 104; (b) in response thereto, encodes such digitized images into a binary logic bit stream (e.g., H.264 encoding); and (c) outputs such bit stream to a storage device 108, which receives and stores such bit stream.

A decoding device 110: (a) reads such bit stream from the storage device 108; (b) in response thereto, decodes such bit stream into the video sequence of such digitized images; and (c) outputs such digitized images to a conversion device 112. The conversion device 112: (a) receives such digitized images from the decoding device 110; and (b) outputs such digitized images to a stereoscopic display device 114 (e.g., a display whose optical components enable viewing with 3D effect, such as a stereoscopic 3D liquid crystal display device or a stereoscopic 3D organic electroluminescent display device, without relying on special glasses). The display device 114: (a) receives such digitized images from the conversion device 112; and (b) in response thereto, displays such digitized images (e.g., stereoscopic images of the object 102 and its surrounding foreground and background), which are viewable by a human user 116 (e.g., viewable as anaglyph images with 3D effect through special glasses that filter a left view of such images against being seen by a right eye of the human user 116, and that filter a right view of such images against being seen by a left eye of the human user 116).

Also, the conversion device 112 receives information from the display device 114, such as: (a) information about the display device 114, such as a type and size of a screen of the display device 114; and/or (b) information about the user 116 (e.g., as specified by the user 116 via a touchscreen of the display device 114), such as preferences of the user 116 and a viewing distance of the user 116 away from the display device 114. In response to such information, the conversion device 112: (a) as discussed hereinbelow in connection with FIGS. 2-11, automatically converts such digitized images to selectively adjust their respective convergence planes in accordance with such information; (b) writes such converted digitized images for storage into the storage device 108; and (c) outputs such converted digitized images to the display device 114 (e.g., substantially concurrent with such conversion by the conversion device 112 in real-time, or after the conversion device 112 subsequently reads such converted digitized images from the storage device 108 in response to a command that the user 116 specifies via a touchscreen of the display device 114).

In an alternative embodiment: (a) the encoding device 106 outputs such bit stream directly to the decoding device 110 via a communication channel (e.g., Ethernet, Internet, or wireless communication channel); and (b) accordingly, the decoding device 110 receives and processes such bit stream directly from the encoding device 106 in real-time. In such alternative embodiment, the storage device 108 either: (a) concurrently receives (in parallel with the decoding device 110) and stores such bit stream from the encoding device 106; or (b) is absent from the system 100.

The encoding device 106 performs its operations in response to instructions of a computer-readable program that is stored on a computer-readable medium 118 (e.g., hard disk drive, flash memory card, or other nonvolatile storage device). Similarly, the decoding device 110 and the conversion device 112 perform their operations in response to instructions of a computer-readable program that is stored on a computer-readable medium 120. Also, the computer-readable medium 120 stores a database of information for operations of the decoding device 110 and the conversion device 112. The system 100 is formed by electronic circuitry components for performing the system 100 operations, implemented in a suitable combination of software, firmware and hardware, such as one or more digital signal processors (“DSPs”), microprocessors, discrete logic devices, application specific integrated circuits (“ASICs”), and field-programmable gate arrays (“FPGAs”).

FIG. 2 is a diagram of viewing axes of a human's eyes. In the example of FIG. 2, a stereoscopic image is displayed by the display device 114 on a screen (which is a convergence plane). The human experiences the 3D effect by viewing the image on the display device 114, so that various features (e.g., objects) appear on the screen (e.g., at a point D1), behind the screen (e.g., at a point D2), and/or in front of the screen (e.g., at a point D3). The stereoscopic image includes a matched pair of left and right views, namely: (a) a left image for viewing by the human's left eye; and (b) a right image for viewing by the human's right eye.

Within the stereoscopic image, a feature's disparity is a horizontal shift between: (a) such feature's location within the left image; and (b) such feature's location within the right image. A limit of such disparity (“maximum disparity”) is dependent on the camera system 104. For example, if a feature (within the stereoscopic image) is horizontally centered on the point D1 within the left image, and likewise horizontally centered on the point D1 within the right image, then the human will perceive the feature to appear at the point D1 with zero horizontal disparity on the screen, which is a natural convergence distance away from the human's eyes.

By comparison, if the feature is horizontally centered on a point P1 within the left image, and horizontally centered on a point P2 within the right image, then the human will perceive the feature to appear at the point D2 with positive disparity behind the screen, which is greater than the natural convergence distance away from the human's eyes. Conversely, if the feature is horizontally centered on the point P2 within the left image, and horizontally centered on the point P1 within the right image, then the human will perceive the feature to appear at the point D3 with negative disparity in front of the screen, which is less than the natural convergence distance away from the human's eyes. The amount of disparity (e.g., horizontal shift of the feature from P1 to P2) is variable on a pixel-by-pixel basis.

Interocular distance is a horizontal spacing between the dual imaging sensors of the camera system 104. The 3D effect will be distorted if the interocular distance is: (a) too large, which exaggerates the 3D effect and thereby causes features to appear smaller than their actual sizes; or (b) too small, which diminishes the 3D effect and thereby causes features to appear larger than their actual sizes. Such distortion is more noticeable in close foreground or far background.

If the interocular distance decreases, then a minimum convergence distance decreases for the camera system 104. Depth of field is a distance between the minimum convergence distance and a maximum convergence distance for the camera system 104. If a stereoscopic image's depth of field is too large, then it can strain the user 116 in viewing of such image with 3D effect. Also, if such image is enlarged (e.g., magnified), then such enlargement can impact quality of the 3D effect in a scene dependent manner, because such enlargement proportionately increases the minimum convergence distance and thereby changes such image's depth of field.

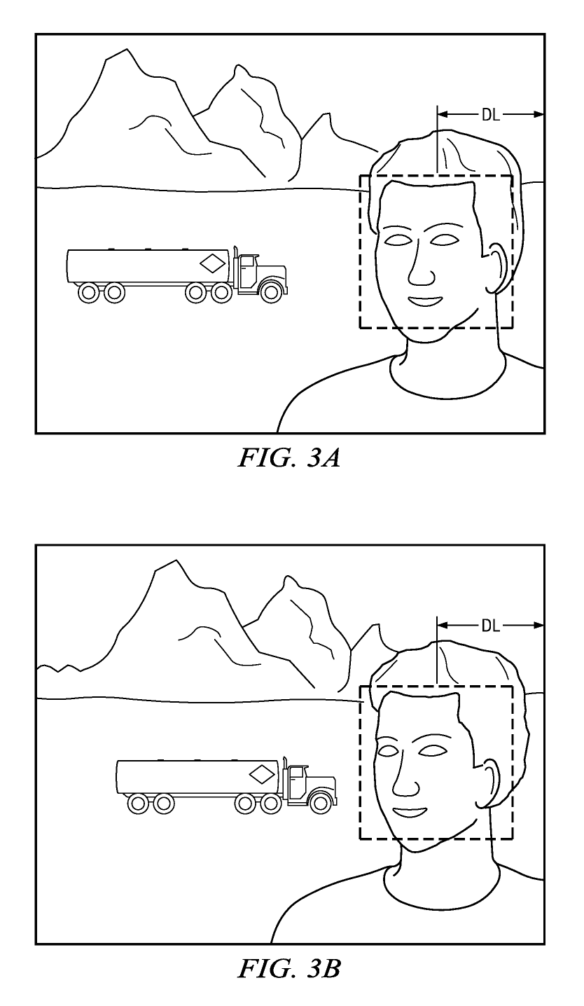

FIG. 3A is a diagram of a left image for viewing by the human's left eye on the display device 114. FIG. 3B is a diagram of a right image for viewing by the human's right eye on the display device 114. Accordingly, the left image (FIG. 3A) and the right image (FIG. 3B) together form a stereoscopic image on the display device 114. Portions of the image (e.g., features, such as objects, within the image) include a mountain range, a truck, and a person's face.

As shown in FIG. 3A, the person's face is horizontally centered on a point that is located a distance DL (at a horizontal coordinate) away from the left image's right edge. Likewise, as shown in FIG. 3B, the person's face is horizontally centered on a point that is located the same distance DL (at the equal horizontal coordinate as its matched point in FIG. 3A) away from the right image's right edge. Accordingly, the person's face is horizontally centered on such coordinate, so the human will perceive the person's face to appear on the screen, which is a natural convergence distance away from the human's eyes. By comparison, the mountain range and the truck within the left image of FIG. 3A are left of the mountain range and the truck within the right image of FIG. 3B (similar to the FIG. 2 example of a feature within the left image at the point P1, which is left of the same feature within the right image at the point P2), so the human will perceive the mountain range and the truck to appear behind the screen.

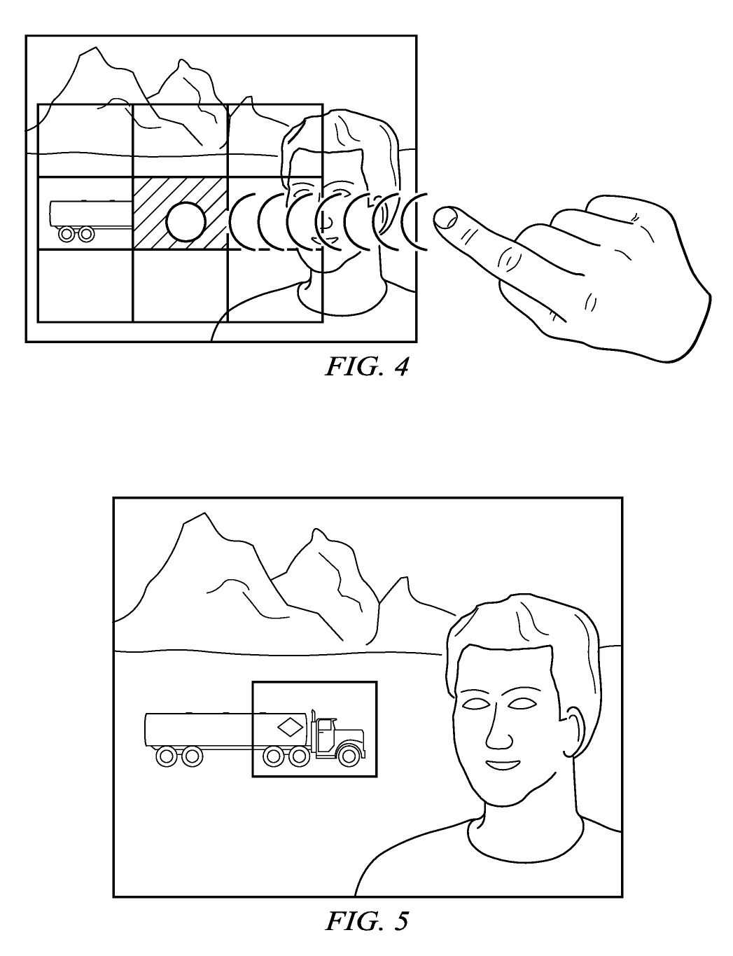

FIG. 4 is a diagram of a touchscreen of the display device 114 in a first embodiment. In one example, the touchscreen is a display screen with a touch panel overlay, which: (a) detects presence and location of a physical touch (e.g., by a finger of the user 116, and/or by a passive stylus object) within a display area of such display screen; and (b) in response thereto, outputs signals (indicative of such detected presence and location) to the conversion device 112. As shown in FIG. 4, the user 116 can touch (e.g., single tap) the display device 114 to select a portion (e.g., region) of the stereoscopic image. Also, the user 116 can touch (e.g., double tap) the display device 114 to cause magnification (e.g., zooming) of the selected portion, so that the touchscreen displays an enlarged (e.g., magnified) version of the selected portion.

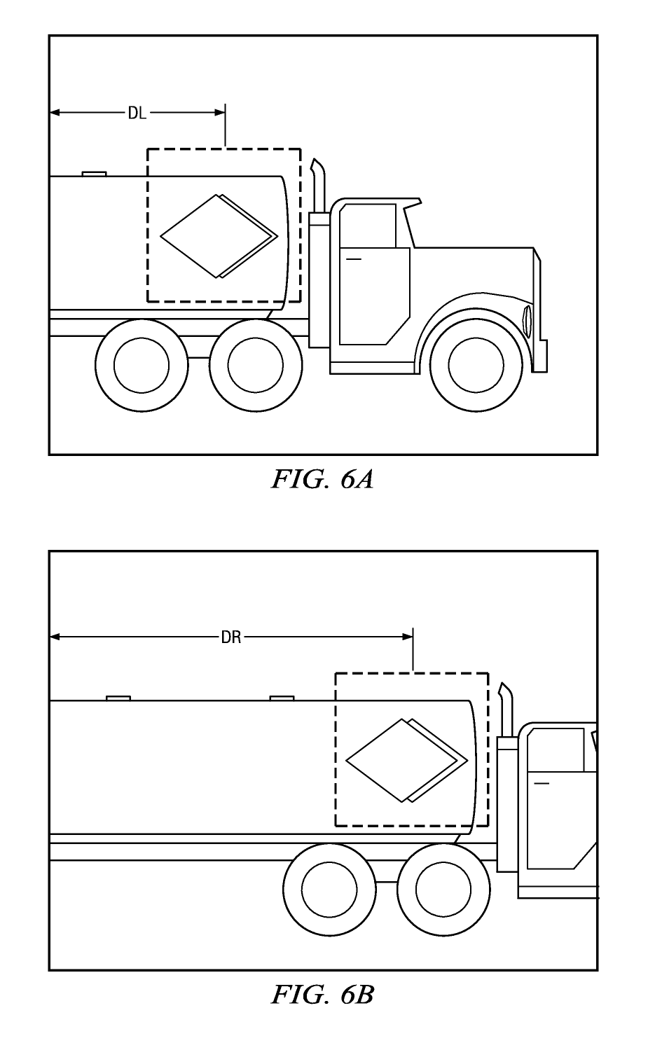

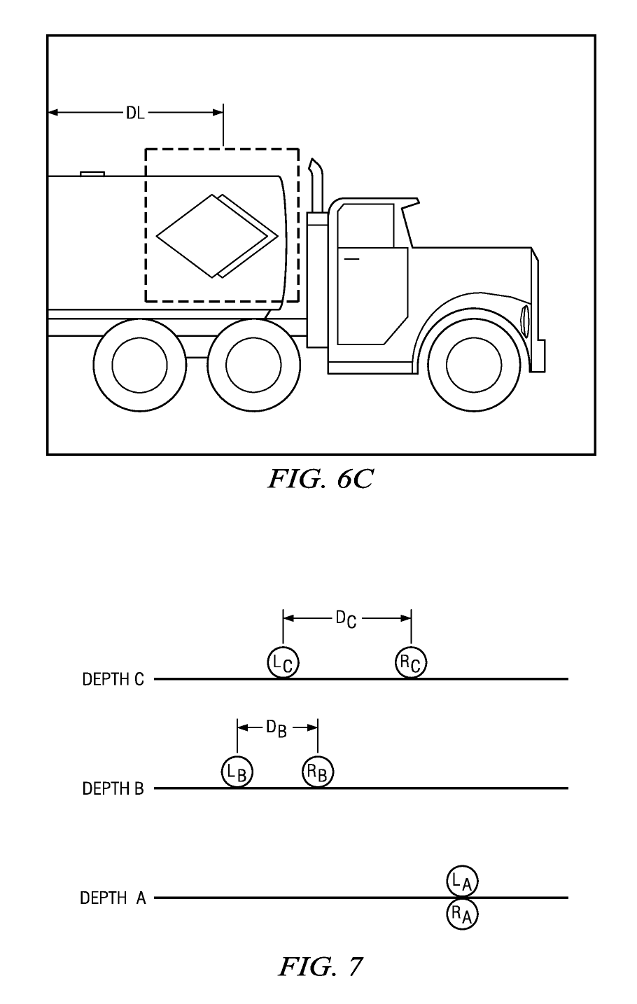

FIG. 5 is a diagram of the touchscreen, on which the user 116 has selected a portion that displays a portion of the truck. FIG. 6A is a diagram of an enlarged version (e.g., magnified version) of the left image of FIG. 3A for viewing (on the touchscreen) by a left eye of the user 116, after the user 116 has caused the touchscreen to display such enlarged version. FIG. 6B is a diagram of an enlarged version of the right image of FIG. 3B for viewing (on the touchscreen) by a right eye of the user 116, after the user 116 has caused the touchscreen to display such enlarged version.

The truck within the left image of FIG. 6A is left of the truck within the right image of FIG. 6B (similar to FIGS. 3A and 3B), so the user 116 will perceive the truck to appear behind the touchscreen. Similarly, the user 116 will perceive the remainder of FIGS. 6A and 6B to appear behind the touchscreen, because the person's face is absent from the enlarged versions (FIGS. 6A and 6B). However, such absence can strain the user 116 in viewing of the image with 3D effect, especially if such absence causes larger disparities between the left and right images of the enlarged versions (FIGS. 6A and 6B) as displayed on the touchscreen.

Accordingly, the conversion device 112 automatically converts the enlarged versions to selectively adjust their convergence plane by horizontally centering a portion of the image on a new coordinate for the enlarged versions. In the example of FIGS. 6A and 6B, such portion is shown by dashed enclosures. In one embodiment, the user 116 can touch the display device 114 to select locations of the dashed enclosures, which are horizontally centered on the new coordinate. If the user 116 does not select locations of the dashed enclosures, then the conversion device 112 automatically: (a) detects (e.g., recognizes) one or more features (e.g., disparity features and/or convergence features) within the enlarged versions; and (b) selects the new coordinate in response to a programmable combination of the 3D safety specification, the image's original convergence plane, the types of detected features, relative locations of detected features within the enlarged versions, relative depths of detected features within the enlarged versions, and/or relative disparities of detected features within the enlarged versions). In that manner, the enlarged versions will conform to the 3D safety specification, and the user 116 will perceive that the new coordinate appears on the touchscreen.

As shown in FIG. 6A, the dashed enclosure is horizontally centered on a point that is located a distance DL (at a horizontal coordinate) away from the left image's left edge. By comparison, as shown in FIG. 6B, the dashed enclosure is horizontally centered on a point that is located a distance DR away from the right image's left edge. In this example, the conversion device 112 adjusts the enlarged versions' convergence plane by horizontally shifting the entire right image of FIG. 6B in a left direction (in an amount of a disparity DR−DL) until the new coordinate is located the distance DL away from such right image's left edge, so that the dashed enclosure in such right image is horizontally centered with the dashed enclosure in the left image of FIG. 6A.

FIG. 6C is a diagram of the enlarged version of the right image of FIG. 3B, after the conversion device 112 has so adjusted the convergence plane. As shown in FIG. 6C, the dashed enclosure is horizontally centered on a point that is located the same distance DL (at the equal horizontal coordinate as its matched point in FIG. 6A) away from such right image's left edge. Accordingly, in FIGS. 6A and 6C, the dashed enclosure is horizontally centered on the new coordinate, so the user 116 will perceive the new coordinate (centered within the dashed enclosure) to appear on the touchscreen, which is a natural convergence distance away from eyes of the user 116. After such adjustment, the conversion device 112: (a) writes the enlarged versions and/or the new coordinate for storage into the storage device 108; and (b) outputs the enlarged versions to the display device 114 for display to the user 116.

In a first alternative example, the conversion device 112 adjusts the enlarged versions' convergence plane by horizontally shifting the entire left image of FIG. 6A in a right direction (in an amount of the disparity DR−DL) until the new coordinate is located the distance DR away from such left image's left edge, so that the dashed enclosure in such left image is horizontally centered with the dashed enclosure in the right image of FIG. 6B. In a second alternative example, the conversion device 112 adjusts the enlarged versions' convergence plane by horizontally shifting the entire left image of FIG. 6A in a right direction (in an amount of one-half of the disparity DR−DL), and by horizontally shifting the entire right image of FIG. 6B in a left direction (in an amount of one-half of the disparity DR−DL), until the dashed enclosure in such left image is horizontally centered with the dashed enclosure in such right image.

FIG. 7 is a diagram of features at various depths within the stereoscopic image of FIGS. 3A and 3B. Within the image, features include: (a) the mountain range at a depth C, which is horizontally centered on a point L_{C} within the left image (FIG. 3A) and horizontally centered on a point R_{C} within the right image (FIG. 3B), where a disparity D_{C}=R_{C}−L_{C} is shown in FIG. 7; (b) the truck at a depth B, which is horizontally centered on a point L_{B} within the left image (FIG. 3A) and horizontally centered on a point R_{B} within the right image (FIG. 3B), where a disparity D_{B}=R_{B}−L_{B} is shown in FIG. 7; and (c) the person's face, which is horizontally centered on a point L_{A} within the left image (FIG. 3A) and horizontally centered on a point R_{A} within the right image (FIG. 3B), where a disparity D_{A}=R_{A}−L_{A}=0, so the user 116 will perceive the person's face to appear on the screen.

The conversion device 112 automatically determines whether the image's existing convergence plane conforms to the 3D safety specification. The conversion device 112 performs such determination in response to: (a) a size of the image as displayed on the display device 114 (e.g., as displayed within a variably-sized window on the display device 114); (b) a type of the display device 114; and (c) a viewing distance of the user 116 away from the display device 114. For example, the conversion device 112 automatically determines whether the 3D safety specification is violated by a disparity between: (a) a feature's horizontally centered point within a version of the left image as displayed on the display device 114 (“displayable version of the left image”); and (b) such feature's horizontally centered point within a version of the right image as displayed on the display device 114 (“displayable version of the right image”).

With reference to FIG. 7, D_{B} and D_{C} will increase or decrease in proportion to size of the displayable versions, which is enlarged by: (a) enlargement of a screen of the display device 114; and/or (b) enlargement of a variably-sized window in which the image is displayed on the display device 114. In the example of FIG. 1, the conversion device 112 receives (from the display device 114): (a) information about the type and size of the screen of the display device 114; and (b) information about the viewing distance of the user 116 away from the display device 114. If the displayable versions are sufficiently large for causing D_{B} or D_{C} to violate the 3D safety specification (according to the type of the display device 114 and the viewing distance of the user 116 away from the display device 114), then such excess can strain the user 116 in viewing of the image with 3D effect.

Accordingly, in response to the conversion device 112 determining that the 3D safety specification is so violated, the conversion device 112 automatically converts the displayable versions to selectively adjust their convergence plane by horizontally centering a portion of the image on a new coordinate for the displayable versions. For such conversion, the conversion device 112 automatically: (a) detects one or more features within the displayable versions; and (b) selects the new coordinate in response to a programmable combination of the 3D safety specification, the image's original convergence plane, the types of detected features, relative locations of detected features within the displayable versions, relative depths of detected features within the displayable versions, and/or relative disparities of detected features within the displayable versions. In that manner, the displayable versions will conform to the 3D safety specification, and the user 116 will perceive that the new coordinate appears on the screen. In an alternative embodiment, the user 116 can touch the display device 114 to select the new coordinate (e.g., by selecting locations of dashed enclosures that are horizontally centered on the new coordinate).

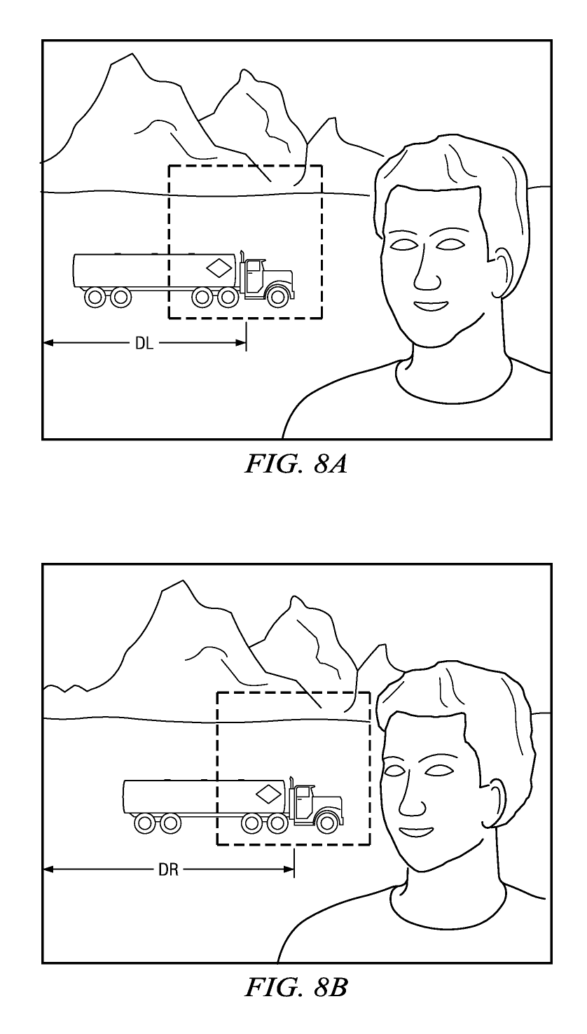

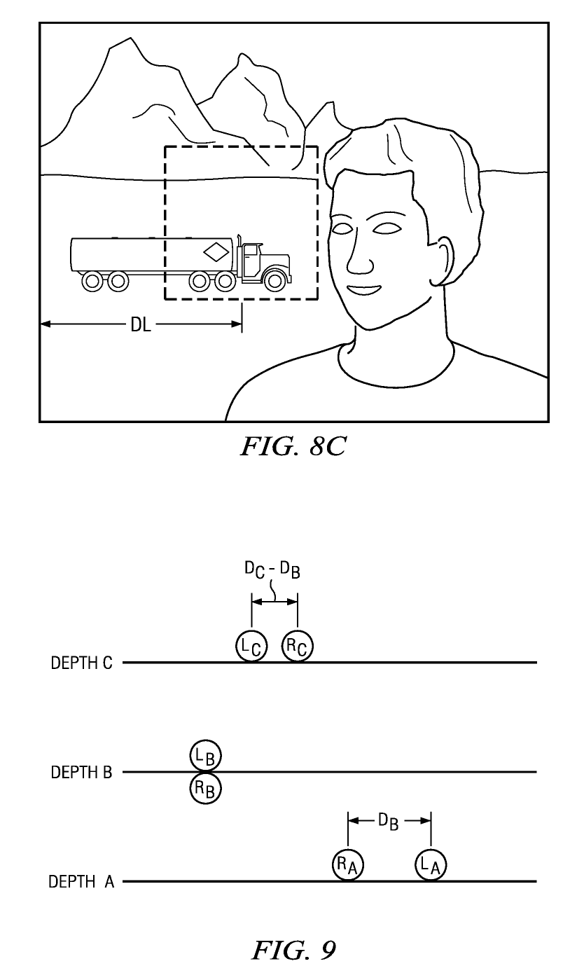

FIG. 8A is a diagram of the left image of FIG. 3A, in which the conversion device 112 has selected a new coordinate, which is shown by a dashed enclosure that is horizontally centered on the new coordinate. FIG. 8B is a diagram of the right image of FIG. 3B, in which the conversion device 112 has likewise selected the same new coordinate, which is shown by a dashed enclosure that is horizontally centered on the new coordinate. As shown in FIG. 8A, the new coordinate is located a distance DL (at a horizontal coordinate) away from the left image's left edge.

By comparison, as shown in FIG. 8B, the new coordinate is located a distance DR away from the right image's left edge. In this example, the conversion device 112 adjusts the displayable versions' convergence plane by horizontally shifting (in an amount of a disparity DR−DL) the entire right image of FIG. 8B in a left direction until the new coordinate is located the distance DL away from such right image's left edge, so that the dashed enclosure in such right image is horizontally centered with the dashed enclosure in the left image of FIG. 8A. For example, if the dashed enclosure is centered on the truck, then the disparity DR−DL (of FIGS. 8A and 8B) is equal to the disparity D_{B}=R_{B}−L_{B} (of FIG. 7).

FIG. 8C is a diagram of the displayable version of the right image of FIG. 3B, after the conversion device 112 has so adjusted the convergence plane. As shown in FIG. 8C, the dashed enclosure is horizontally centered on a point that is located the same distance DL (at the equal horizontal coordinate as its matched point in FIG. 8A) away from such right image's left edge. Accordingly, in FIGS. 8A and 8C, the dashed enclosure is horizontally centered on the new coordinate, so the user 116 will perceive the new coordinate (centered within the dashed enclosure) to appear on the screen, which is a natural convergence distance away from eyes of the user 116. After such adjustment, the conversion device 112: (a) writes the displayable versions and/or the new coordinate for storage into the storage device 108; and (b) outputs the displayable versions to the display device 114 for display to the user 116.

In a first alternative example, the conversion device 112 adjusts the displayable versions' convergence plane by horizontally shifting the entire left image of FIG. 8A in a right direction (in an amount of the disparity DR−DL) until the new coordinate is located the distance DR away from such left image's left edge, so that the dashed enclosure in such left image is horizontally centered with the dashed enclosure in the right image of FIG. 8B. In a second alternative example, the conversion device 112 adjusts the displayable versions' convergence plane by horizontally shifting the entire left image of FIG. 8A in a right direction (in an amount of one-half of the disparity DR−DL), and by horizontally shifting the entire right image of FIG. 8B in a left direction (in an amount of one-half of the disparity DR−DL), until the dashed enclosure in such left image is horizontally centered with the dashed enclosure in such right image.

FIG. 9 is a diagram of features at various depths within the stereoscopic image, after the conversion device 112 has so adjusted the convergence plane. In the example of FIG. 9: (a) the dashed enclosure is centered on the truck at the depth B; and (b) the conversion device 112 has adjusted the displayable versions' convergence plane by horizontally shifting (in an amount of the disparity D_{B}) the entire right image of FIG. 8B in a left direction, so that the truck in such right image is horizontally centered with the truck in the left image of FIG. 8A. As shown in FIG. 9, L_{B} is the truck's horizontally centered point within the left image (FIG. 8A), and R_{B} is the truck's horizontally centered point within the right image (FIG. 8B), where a disparity R_{B}−L_{B}=D_{B}−D_{B}=0, so the user 116 will perceive the truck to appear on the screen (because the truck is horizontally centered on the new coordinate).

Likewise, for the mountain range at the depth C, a disparity between R_{C} and L_{C} has been reduced to D_{C}−D_{B} in FIG. 9, so that such reduced disparity (D_{C}−D_{B}) conforms to the 3D safety specification (whereas the mountain range's previous disparity D_{C} in FIG. 7 violated the 3D safety specification) for this example's particular: (a) size of the displayable versions; (b) type of the display device 114; and (c) viewing distance of the user 116 away from the display device 114. For the person's face at the depth A, a disparity between R_{A} and L_{A} has been increased to D_{B} (instead of 0), but such increased disparity still conforms to the 3D safety specification for this example's particular: (a) size of the displayable versions; (b) type of the display device 114; and (c) viewing distance of the user 116 away from the display device 114. After the conversion device 112 has so adjusted the convergence plane as shown in FIG. 9: (a) the user 116 will continue perceiving the mountain range to appear behind the screen; and (b) the user 116 will perceive the person's face to appear in front of the screen.

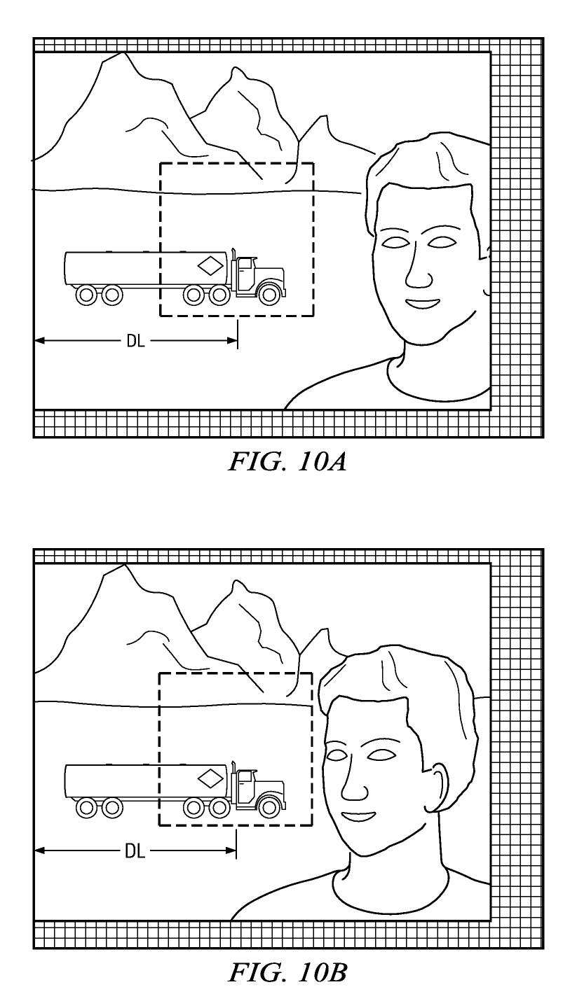

FIG. 10A is a diagram of a cropped version of the left image of FIG. 8A, after the conversion device 112 has so adjusted the convergence plane. FIG. 10B is a diagram of a cropped version of the right image of FIG. 8C. For example, in horizontally shifting the entire right image of FIG. 8B in a left direction, additional right image information (e.g., beyond a right edge of the right image of FIG. 8B) might be unavailable to the conversion device 112. In response to such unavailability, the conversion device 112 automatically: (a) crops the right image to include only available information, while preserving the right image's aspect ratio, as shown in FIG. 10B; (b) for consistency between the left and right images, crops the left image to a same extent as the right image, as shown in FIG. 10A; and (c) optionally, magnifies the cropped versions of the left and right images to restore their original dimensions that existed before such cropping.

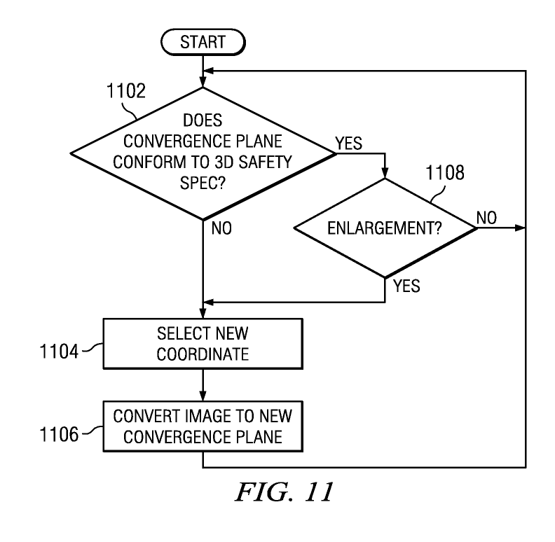

FIG. 11 is a flowchart of operation of the conversion device 112. The operation begins at a step 1102, at which the conversion device 112 automatically determines whether the displayable versions' existing convergence plane conforms to the 3D safety specification. For example, at the step 1102, the conversion device 112 automatically determines whether the 3D safety specification is violated by a disparity between the following (as discussed hereinabove in connection with FIG. 7): (a) a feature's horizontally centered point within the displayable version of the left image; and (b) such feature's horizontally centered point within the displayable version of the right image. In response to the conversion device 112 determining that the 3D safety specification is so violated, the operation continues to a step 1104, at which the conversion device 112 selects a new coordinate for the displayable versions. As discussed hereinabove in connection with FIGS. 5-7, the selection of the new coordinate is either: (a) automatically performed by the conversion device 112; or (b) received by the conversion device 112 from the user 116 (e.g., by the user 116 touching the display device 114 to select locations of dashed enclosures that are horizontally centered on the new coordinate).

After the step 1104, the operation continues to a next step 1106, at which the conversion device 112 automatically converts the displayable versions to selectively adjust their convergence plane by horizontally centering a portion of the image on the new coordinate for the displayable versions, as discussed hereinabove in connection with FIGS. 7-10. After the step 1106: (a) the conversion device 112 writes the displayable versions and/or the new coordinate for storage into the storage device 108; (b) the conversion device 112 outputs the displayable versions to the display device 114 for display to the user 116; and (c) the operation returns to the step 1102 for either (i) repeated processing of the same image or (ii) processing of a next image. With reference to the step 1102, in response to the conversion device 112 determining that the displayable versions' existing convergence plane conforms to the 3D safety specification, the operation continues to a step 1108.

At the step 1108, the conversion device 112 determines whether the user 116 has caused enlargement of the image (as discussed hereinabove in connection with FIGS. 4 and 5). In response to the conversion device 112 determining that the user 116 has not caused enlargement of the image, the operation returns to the step 1102 for either: (a) repeated processing of the same image (e.g., because the user 116 may subsequently cause enlargement of a window that displays the full or partial image on the display device 114, such as by enlarging a variably-sized window and/or zooming a full-sized or variably-sized window); or (b) processing of a next image. Conversely, in response to the conversion device 112 determining that the user 116 has caused enlargement of the image, the operation continues from the step 1108 to: (a) the step 1104 for selection of the new coordinate for the enlarged versions; and (b) the next step 1106 for automatically converting the enlarged versions to selectively adjust their convergence plane by horizontally centering a portion of the image on the new coordinate for the enlarged versions, as discussed hereinabove in connection with FIGS. 6A, 6B and 6C. After the step 1106: (a) the conversion device 112 writes the enlarged versions and/or the new coordinate for storage into the storage device 108; (b) the conversion device 112 outputs the enlarged versions to the display device 114 for display to the user 116; and (c) the operation returns to the step 1102 for either (i) repeated processing of the same image or (ii) processing of a next image.

In the illustrative embodiments, a computer program product is an article of manufacture that has: (a) a computer-readable medium; and (b) a computer-readable program that is stored on such medium. Such program is processable by an instruction execution apparatus (e.g., system or device) for causing the apparatus to perform various operations discussed hereinabove (e.g., discussed in connection with a block diagram). For example, in response to processing (e.g., executing) such program's instructions, the apparatus (e.g., programmable information handling system) performs various operations discussed hereinabove. Accordingly, such operations are computer-implemented.

Such program (e.g., software, firmware, and/or microcode) is written in one or more programming languages, such as: an object-oriented programming language (e.g., C++); a procedural programming language (e.g., C); and/or any suitable combination thereof. In a first example, the computer-readable medium is a computer-readable storage medium. In a second example, the computer-readable medium is a computer-readable signal medium.

A computer-readable storage medium includes any system, device and/or other non-transitory tangible apparatus (e.g., electronic, magnetic, optical, electromagnetic, infrared, semiconductor, and/or any suitable combination thereof) that is suitable for storing a program, so that such program is processable by an instruction execution apparatus for causing the apparatus to perform various operations discussed hereinabove. Examples of a computer-readable storage medium include, but are not limited to: an electrical connection having one or more wires; a portable computer diskette; a hard disk; a random access memory (“RAM”); a read-only memory (“ROM”); an erasable programmable read-only memory (“EPROM” or flash memory); an optical fiber; a portable compact disc read-only memory (“CD-ROM”); an optical storage device; a magnetic storage device; and/or any suitable combination thereof.

A computer-readable signal medium includes any computer-readable medium (other than a computer-readable storage medium) that is suitable for communicating (e.g., propagating or transmitting) a program, so that such program is processable by an instruction execution apparatus for causing the apparatus to perform various operations discussed hereinabove. In one example, a computer-readable signal medium includes a data signal having computer-readable program code embodied therein (e.g., in baseband or as part of a carrier wave), which is communicated (e.g., electronically, electromagnetically, and/or optically) via wireline, wireless, optical fiber cable, and/or any suitable combination thereof.

Although illustrative embodiments have been shown and described by way of example, a wide range of alternative embodiments is possible within the scope of the foregoing disclosure.

What is claimed is:

1. A method performed by an information handling system for re-convergence of a stereoscopic image, the method comprising:
receiving first and second views of the stereoscopic image, wherein a first portion of the stereoscopic image is located at a first coordinate that is equal within the first and second views; and
for displaying enlarged versions of the first and second views, shifting at least one of the first and second views, so that a second portion of the stereoscopic image is located at a second coordinate that is equal within the enlarged versions.

2. The method of claim 1, wherein: the first and second views are left and right views, respectively; and the first and second coordinates are horizontal coordinates.

3. The method of claim 1, wherein the first portion includes a first feature within the first and second views, and wherein the second portion includes a second feature within the first and second views.

4. The method of claim 1, and comprising: displaying the enlarged versions on a screen of a display.

5. The method of claim 4, wherein displaying the enlarged versions includes zooming the screen.

6. The method of claim 4, wherein displaying the enlarged versions includes enlarging a variably-sized window on the screen.

7. The method of claim 4, and comprising: selecting the second coordinate in response to a safety specification and a size of the enlarged versions as displayed on the screen.

8. The method of claim 7, wherein selecting the second coordinate includes: detecting one or more features within the enlarged versions; and selecting the second coordinate in response to disparities between first locations of the detected features within the first view and second locations of the detected features within the second view.

9. The method of claim 4, and comprising: receiving a selection of the second coordinate from a human user.

10. The method of claim 9, wherein the screen includes a touchscreen, and wherein receiving the selection of the second coordinate includes: receiving the selection of the second coordinate from the human user through the touchscreen.

11. A system for re-convergence of a stereoscopic image, the system comprising:
at least one device for: receiving first and second views of the stereoscopic image, wherein a first portion of the stereoscopic image is located at a first coordinate that is equal within the first and second views; and, for displaying enlarged versions of the first and second views, shifting at least one of the first and second views, so that a second portion of the stereoscopic image is located at a second coordinate that is equal within the enlarged versions.

12. The system of claim 11, wherein: the first and second views are left and right views, respectively; and the first and second coordinates are horizontal coordinates.

13. The system of claim 11, wherein the first portion includes a first feature within the first and second views, and wherein the second portion includes a second feature within the first and second views.

14. The system of claim 11, and comprising a display for displaying the enlarged versions on a screen of the display.

15. The system of claim 14, wherein the display is for zooming the screen to display the enlarged versions.

16. The system of claim 14, wherein the display is for enlarging a variably-sized window on the screen to display the enlarged versions.

17. The system of claim 14, wherein the device is for: selecting the second coordinate in response to a safety specification and a size of the enlarged versions as displayed on the screen.

18. The system of claim 17, wherein the device is for: detecting one or more features within the enlarged versions; and selecting the second coordinate in response to disparities between first locations of the detected features within the first view and second locations of the detected features within the second view.

19. The system of claim 14, wherein the device is for: receiving a selection of the second coordinate from a human user.

20. The system of claim 19, wherein the screen includes a touchscreen, and wherein the device is for: receiving the selection of the second coordinate from the human user through the touchscreen.

21. A computer program product for re-convergence of a stereoscopic image, the computer program product comprising:
a tangible computer-readable storage medium; and
a computer-readable program stored on the tangible computer-readable storage medium, wherein the computer-readable program is processable by an information handling system for causing the information handling system to perform operations including: receiving first and second views of the stereoscopic image, wherein a first portion of the stereoscopic image is located at a first coordinate that is equal within the first and second views; and, for displaying enlarged versions of the first and second views, shifting at least one of the first and second views, so that a second portion of the stereoscopic image is located at a second coordinate that is equal within the enlarged versions.

22. The computer program product of claim 21, wherein: the first and second views are left and right views, respectively; and the first and second coordinates are horizontal coordinates.

23. The computer program product of claim 21, wherein the first portion includes a first feature within the first and second views, and wherein the second portion includes a second feature within the first and second views.

24. The computer program product of claim 21, wherein the operations include: displaying the enlarged versions on a screen of a display.

25. The computer program product of claim 24, wherein displaying the enlarged versions includes zooming the screen.

26. The computer program product of claim 24, wherein displaying the enlarged versions includes enlarging a variably-sized window on the screen.

27. The computer program product of claim 24, wherein the operations include: selecting the second coordinate in response to a safety specification and a size of the enlarged versions as displayed on the screen.

28. The computer program product of claim 27, wherein selecting the second coordinate includes: detecting one or more features within the enlarged versions; and selecting the second coordinate in response to disparities between first locations of the detected features within the first view and second locations of the detected features within the second view.

29. The computer program product of claim 24, wherein the operations include: receiving a selection of the second coordinate from a human user.

30. The computer program product of claim 29, wherein the screen includes a touchscreen, and wherein receiving the selection of the second coordinate includes: receiving the selection of the second coordinate from the human user through the touchscreen.
